(19) United States
(12) Patent Application Publication
(10) Pub. No.: US 2024/0087781 A1
(43) Pub. Date: Mar. 14, 2024

(54) POWDER MAGNETIC CORE, INDUCTOR, AND METHOD OF MANUFACTURING POWDER MAGNETIC CORE

(71) Applicant: TOKIN Corporation, Sendai-shi (JP)

(72) Inventors: Makoto YAMAKI, Sendai-shi (JP); Naoto ONISHI, Sendai-shi (JP); Akiri URATA, Sendai-shi (JP); Kenichiro KOBAYASHI, Sendai-shi (JP); Yu KANAMORI, Sendai-shi (JP); Hiroshi SHIMA, Sendai-shi (JP); Shun MIKOSHIBA, Sendai-shi (JP)

(21) Appl. No.: 18/360,729

(22) Filed: Jul. 27, 2023

(30) Foreign Application Priority Data
Sep. 9, 2022 (JP) 2022-144030

(51) Int. Cl. H01F 1/153; H01F 3/08; H01F 41/02

(52) U.S. Cl. CPC H01F 1/15341; H01F 3/08; H01F 41/0246

(57) ABSTRACT

A powder magnetic core capable of achieving a low loss in a high frequency range is provided. A powder magnetic core according to the present disclosure is a powder magnetic core in which a magnetic powder is bonded via a binder layer. A volume filling percentage of the magnetic powder included in the powder magnetic core is 85 volume % or higher, and a value obtained by dividing a BET specific surface area (m²/g) of the powder magnetic core by a specific surface area (m²/g) calculated using outer dimensions of the powder magnetic core is 5000 or less.

### INCORPORATION BY REFERENCE

This application is based upon and claims the benefit of priority from Japanese patent application No. 2022-144030, filed on Sep. 9, 2022, the disclosure of which is incorporated herein in its entirety by reference.

### BACKGROUND

The present disclosure relates to a powder magnetic core, an inductor, and a method for manufacturing a powder magnetic core.

In recent years, inductors have been used in a variety of electronic devices. Inductors used in electronic devices such as personal computers, in particular, are required to be small in size and to exhibit high inductance characteristics even when a large current is made to flow through the inductors. Japanese Unexamined Patent Application Publication No. H10-212503 discloses a method for manufacturing a pressed powder body of amorphous magnetically soft alloy having less diminished in magnetic permeability in a high frequency range.

### SUMMARY

As described above, it is required that inductors have a small size and exhibit high inductance characteristics even when a large current is made to flow through the inductors. In particular, since inductors that are used in electronic devices such as personal computers are used in a high frequency range (e.g., 750 kHz-2 MHz), an inductor having a low loss in a high frequency range is required.

In view of the aforementioned problem, the present disclosure aims to provide a powder magnetic core, an inductor, and a method for manufacturing a powder magnetic core capable of achieving a low loss in a high frequency range.

A powder magnetic core according to one aspect of the present disclosure is a powder magnetic core in which a magnetic powder is bonded via a binder layer, in which a volume filling percentage of the magnetic powder included in the powder magnetic core is 85 volume % or higher, and a value obtained by dividing a BET specific surface area (m²/g) of the powder magnetic core by a specific surface area (m²/g) calculated using outer dimensions of the powder magnetic core is 5000 or less.

An inductor according to one aspect of the present disclosure includes the above powder magnetic core and a coil.

A method for manufacturing a powder magnetic core according to one aspect of the present disclosure includes: a process of coating a magnetic powder with a low melting glass; a process of coating the magnetic powder coated with the low melting glass with a resin material for granulation; and a process of hot forming the magnetic powder after the granulation. A volume filling percentage of the magnetic powder included in the powder magnetic core after the hot forming is 85 volume % or higher, and a value obtained by dividing a BET specific surface area (m²/g) of the powder magnetic core after the hot forming by a specific surface area (m²/g) calculated using outer dimensions of the powder magnetic core is 5000 or less.

According to the present disclosure, it is possible to provide a powder magnetic core, an inductor, and a method for manufacturing a powder magnetic core capable of achieving a low loss in a high frequency range.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing one example of an inductor according to an embodiment;

FIG. 2 is a flowchart for describing a method for manufacturing the powder magnetic core according to the embodiment;

FIG. 3 is a schematic view for describing the method for manufacturing the powder magnetic core according to the embodiment;

FIG. 4 is a graph showing a relationship between a ratio of specific surface areas of the powder magnetic core, a volume filling percentage, and iron loss (Experiment 1); and

FIG. 5 is a graph showing a relationship between a ratio of specific surface areas of the powder magnetic core, a volume filling percentage, and iron loss (Experiment 2).

### DESCRIPTION OF EMBODIMENTS

### <Inductor>

Hereinafter, with reference to the drawings, an embodiment will be described.

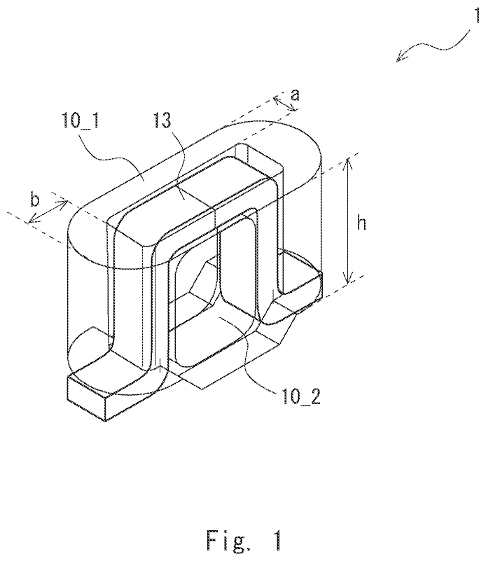

FIG. 1 is a perspective view showing one example of an inductor according to this embodiment. As shown in FIG. 1, an inductor 1 according to this embodiment includes powder magnetic cores 10_1 and 10_2, and a coil 13. The powder magnetic core 10_1, which includes a cavity penetrating the center thereof in the vertical direction, is disposed so as to surround the outer side of the coil 13. The powder magnetic core 10_2, which is provided inside the coil 13, is disposed in a recessed part of the coil 13 having a U-shaped cross section.

For example, the inductor 1 shown in FIG. 1 is formed by arranging the powder magnetic core 10_2 in the recessed part of the coil 13 and press-fitting the powder magnetic core 10_1 from above. Accordingly, the inductor 1 including the coil 13 surrounded by the powder magnetic cores 10_1 and 10_2 can be formed. The powder magnetic cores 10_1 and 10_2 may also be collectively referred to as a powder magnetic core 10 in this description. Further, the structure of the inductor 1 shown in FIG. 1 is merely one example and the powder magnetic core 10 according to this embodiment may be used for an inductor including a structure other than that shown in FIG. 1. The powder magnetic core according to this embodiment achieves a low loss in a high frequency range. Hereinafter, the powder magnetic core according to this embodiment will be described in detail.

### <Powder Magnetic Core>

The powder magnetic core according to this embodiment is a powder magnetic core in which a magnetic powder is bonded via a binder layer. In addition, the powder magnetic core according to this embodiment has a volume filling percentage of the magnetic powder included in the powder magnetic core of 85 volume % or more and a value obtained by dividing a BET specific surface area (m²/g) of the powder magnetic core by the specific surface area (m²/g) calculated using outer dimensions of the powder magnetic core of 5000 or less. With the above structure, the powder magnetic core according to this embodiment can achieve a powder magnetic core having a low loss in a high frequency range.

The magnetic powder used for the powder magnetic core according to this embodiment is a soft magnetic powder containing an iron element. For example, the particle size of the magnetic powder is equal to or larger than 2 μm but equal to or smaller than 100 μm, preferably equal to or larger than 5 μm but equal to or smaller than 50 μm. In this embodiment, the particle size is a median diameter D50. This is a value measured by using a laser diffraction-scattering method.

In this embodiment, an amorphous alloy powder may be used as the magnetic powder. It may be, for example, an Fe—P—B alloy, an Fe—B—P—Nb—Cr alloy, an Fe—Si—B alloy, an Fe—Si—B—P alloy, an Fe—Si—B—P—Cr alloy, or an Fe—Si—B—P—C alloy. By rapidly solidifying a molten metal and powdering them by an atomizing method, the amorphous alloy powder can be obtained. Also, among the alloy compositions that are amorphized by the rapid cooling of the molten metal, a metallic glassy alloy powder having a glass transition point at a temperature lower than a crystallization temperature of an amorphous phase may be used. In this embodiment, in particular, an Fe—B—P—Nb—Cr alloy-based material is preferably used. The method for manufacturing an amorphous alloy powder is not limited to the atomizing method, and for example, a powder obtained by grinding a quenched thin strip may be used.

Further, in this embodiment, among the amorphous alloy powders, a powder for nanocrystallization having an alloy composition in which a nanocrystalline phase of nanometer order is precipitated in an amorphous phase by an appropriate heat treatment may be used as the magnetic powder. For example, an amorphous alloy powder prepared by an atomizing method may be used as the powder for nanocrystallization. For example, an Fe—Si—B—P—C—Cu-based material, an Fe—Si—B—Cu—Cr-based material, an Fe—Si—B—P—Cu—Cr-based material, an Fe—B—P—C—Cu-based material, an Fe—Si—B—P—Cu-based material, an Fe—B—P—Cu-based material, or an Fe—Si—B—Nb—Cu-based material is powdered by rapid solidification of a molten metal by using an atomizing method. Then, a nanocrystallized powder including at least two exothermic peaks indicating crystallization in the heat rising process of the magnetic powder can be formed. The amorphous alloy powder for nanocrystallization to be used, which is not particularly limited, may preferably be, for example, an Fe—Si—B—P—Cu—Cr-based material. Moreover, the method for manufacturing an amorphous alloy powder for nanocrystallization is not limited to the atomizing method, and for example, a powder obtained by grinding a quenched thin strip may be used.

In this embodiment, the closer the shape of particles of the magnetic powder is to spherical, the better. When the sphericity of the particles is low, protrusions are formed on the surface of the particles. When a molding pressure is applied, stress from surrounding particles concentrates on the protrusions, causing the coating to break and a sufficiently high insulation cannot be maintained, which may result in deterioration of the magnetic properties (in particular, loss) of the resulting powder magnetic core. The sphericity of the particles may be controlled within a suitable range by adjusting manufacturing conditions of the magnetic powder such as a water volume and a water pressure of high-pressure water jet used for atomization if a water atomizing method is employed, the temperature and the supply rate of a molten material. The specific manufacturing conditions vary depending on the composition of the magnetic powder to be manufactured or the desired productivity.

In the powder magnetic core according to this embodiment, the binder layer includes a function of binding particles of the magnetic powder and a function of insulating particles of the magnetic powder. A resin material may be used for the binder layer, or a low melting glass and a resin material may be used for the binder layer. In this embodiment, the total amount of the low melting glass and the resin material is 12 volume % or less with respect to the amount of the magnetic powder of the powder magnetic core. When the total amount of the low melting glass and the resin material in the binder layer is more than 12 volume %, the percentage of the magnetic powder in the powder magnetic core decreases, making it impossible to obtain satisfactory magnetic properties. The low melting glass may be a phosphate-based glass, a tin phosphate-based glass, a borate-based glass, a silicate-based glass, a boro-silicate-based glass, a bariumsilicate-based glass, a bismuth oxide-based glass, a germanate-based glass, a vanadate-based glass, an aluminophosphate-based glass, an arsenate-based glass, a telluride-based glass or the like. In particular, in this embodiment, a phosphate-based or a tin phosphate-based low melting glass is preferably used. Further, the volume percentage of the low melting glass with respect to the volume of the magnetic powder is equal to or smaller than 6 volume %, preferably equal to or larger than 1 volume % but equal to or smaller than 5 volume %. Sufficient magnetic properties can be achieved even if the volume percentage of the low melting glass is 0 volume %. However, if the volume percentage of the low melting glass is equal to or larger than 1 volume %, satisfactory magnetic properties can be achieved in the high frequency range and radial crushing strength of the powder magnetic core can be further enhanced. Also, if the volume percentage of the low melting glass is more than 6 volume %, the oozing of the low melting glass during forming deteriorates releasability of the powder magnetic core from a die, causing the surface of the powder magnetic core to peel.

Further, the resin material included in the binder layer may be at least one type of resin material selected from the group consisting of a phenol resin, a polyimide resin, an epoxy resin, and an acrylic resin. Further, the volume percentage of the resin material with respect to the volume of magnetic powder is equal to or larger than 0.5 volume % but equal to or smaller than 11 volume %, preferably equal to or larger than 1 volume % but equal to or smaller than 5 volume %. When the volume percentage of the resin material is less than 0.5 volume %, the bonding and insulation properties between the particles of the magnetic powder are reduced. In addition, when the volume percentage of the resin material is more than 11 volume %, the amount of degassing during curing of the resin is increased, thereby causing the powder magnetic core to crack.

In the powder magnetic core according to this embodiment, the volume filling percentage of the magnetic powder included in the powder magnetic core is equal to or larger than 85 volume %, preferably equal to or larger than 88 volume %.

The volume filling percentage can be obtained using the following expression:

Volume filling percentage(%)=(density of the powder magnetic core calculated from the outer dimensions and weight of the powder magnetic core/true density of magnetic powder)×100

In addition, in the powder magnetic core according to this embodiment, a value obtained by dividing a BET specific surface area (m²/g) of the powder magnetic core by the specific surface area (m²/g) calculated using the outer dimensions of the powder magnetic core is equal to or less than 5000, preferably equal to or less than 2000, more preferably equal to or less than 1500, and even more preferably equal to or less than 500. In this specification, “a value obtained by dividing the BET specific surface area (m²/g) of the powder magnetic core after the hot forming by the specific surface area (m²/g) calculated using the outer dimensions of the powder magnetic core” is also referred to as “a ratio of the specific surface areas”. The larger the value, the rougher the surface of the powder magnetic core, whereas the smaller the value, the smoother the surface of the powder magnetic core.

In this embodiment, the iron loss at 1 MHz and 50 mT of the powder magnetic core is equal to or smaller than 2500 kW/m³, preferably equal to or smaller than 1500 kW/m³, and more preferably equal to or smaller than 1000 kW/m³. For example, the iron loss can be measured by means of a B—H analyzer using a toroidal-shaped powder magnetic core. The measurement conditions are a frequency of 1 MHz, a maximum magnetic flux density of 50 mT, and sinusoidal excitation.

Moreover, in this embodiment, the magnetic permeability of the powder magnetic core at 1 MHz is equal to or larger than 50, preferably equal to or larger than 60, more preferably equal to or larger than 80. For example, the magnetic permeability can be measured by means of an impedance analyzer using a toroidal-shaped powder magnetic core. The measurement frequency is 1 MHz.

In addition, the radial crushing strength of the powder magnetic core is equal to or larger than 30 MPa, preferably equal to or larger than 32 MPa, more preferably equal to or larger than 33 MPa, and even more preferably equal to or larger than 37 MPa. For example, the radial crushing strengths is calculated by compressive fracture of a toroidal-shaped powder magnetic core by means of a strength tester.

Also, in this embodiment, a thickness of an oxide layer on the surface of the powder magnetic core is equal to or smaller than 3 mm, preferably equal to or smaller than 2 mm, and more preferably equal to or smaller than 1 mm. When the thickness of the oxide layer exceeds 3 mm, the percentage of the oxide layer in the powder magnetic core increases and the magnetic properties decrease. Further, the surface of the powder magnetic core becomes brittle, and the powder magnetic core tends to chip by external impact. If the thickness of the oxide layer is equal to or smaller than 3 mm, the percentage of the oxide layer in the powder magnetic core can be kept low, and the degradation of the magnetic properties and the embrittlement of the powder magnetic core surface can be suppressed. If the thickness of the oxide layer is equal to or smaller than 2 mm and even equal to or smaller than 1 mm, the percentage of the oxide layer in the powder magnetic core can be kept even lower, and the degradation of the magnetic properties and the embrittlement of the powder magnetic core surface can be suppressed. Note that the thickness of the oxide layer can be obtained by cutting the powder magnetic core, observing a cross section of the powder magnetic core, and then measuring a thickness of a discolored area (a thickness of a discolored layer) in the depth direction from the surface of the powder magnetic core.

### <Method for Manufacturing Powder Magnetic Core>

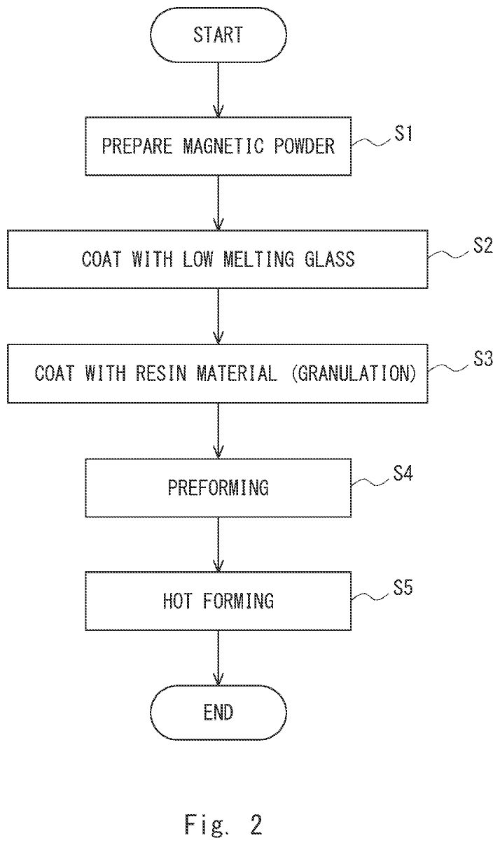

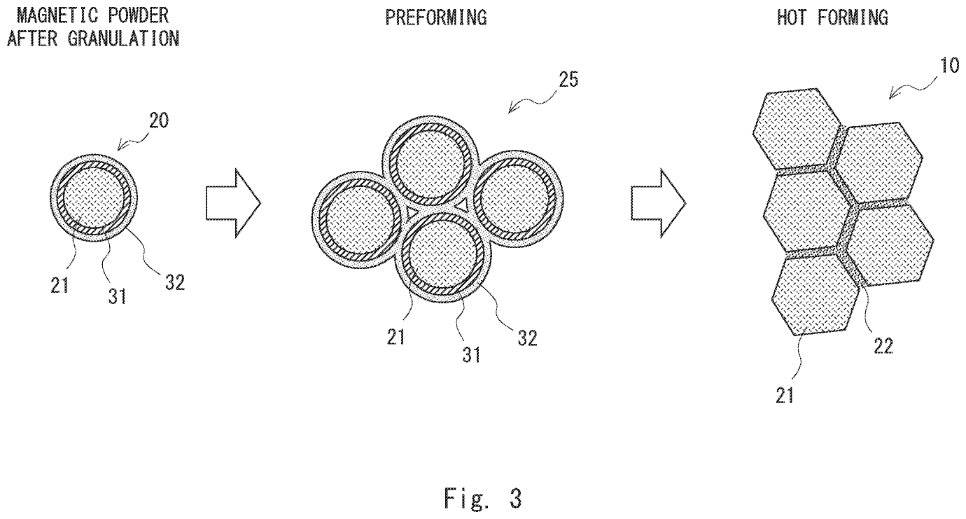

Next, a method for manufacturing the powder magnetic core according to this embodiment will be described. FIG. 2 is a flowchart for describing the method for manufacturing the powder magnetic core according to this embodiment. FIG. 3 is a schematic view for describing the method for manufacturing the powder magnetic core according to this embodiment.

As shown in FIG. 2, when the powder magnetic core is prepared, the magnetic powder is prepared first (Step S1). The magnetic powder may be the aforementioned magnetic powder. The magnetic powder is preferably made of a magnetic material that is softened during hot forming (a material that is easily deformed during hot forming). For example, by vacuum melting raw materials of the magnetic powder and then performing powderization and quenching concurrently using a water atomizing method, an amorphous magnetic powder can be obtained. The magnetic powder thus obtained may be classified as needed to remove abnormally coarsened powder.

Next, the magnetic powder is coated with a low melting glass (Step S2). The low melting glass is preferably made of a material that is softened at high temperatures, that is, a material that is softened during hot forming and serves as an insulation material or a bonding material after hot forming. The low melting glass may be, for example, a phosphate-based glass. When the magnetic powder is coated with the low melting glass, a wet thin-film formation method such as a mechanochemical method or a sol-gel method, or a dry thin-film formation method such as sputtering may be used. For example, according to the mechanochemical method, a layer of the low melting glass can be formed on the surface of the magnetic powder by mixing the magnetic powder with the low melting glass powder while applying a strong mechanical energy.

As one example, 1000 g of magnetic powder is mixed with 10 g of low melting glass powder, and the magnetic powder is coated with the low melting glass using a mechanochemical method. Accordingly, the volume percentage of the low melting glass that coats the magnetic powder with respect to the volume of the magnetic powder may be made equal to or smaller than 6 volume %. The process of coating the magnetic powder with low melting glass (Step S2) may be omitted.

Next, the magnetic powder coated with the low melting glass is coated with the resin material for granulation (Step S3). This resin material may be the aforementioned resin material. The resin material is preferably made of a material that is softened at about 100° C. and serves as an insulation material or a bonding material after hot forming. Further, the resin material is preferably a material that is not likely to be decomposed during hot forming (at a high temperature). When the magnetic powder is coated with the resin material (granulated), a rolling granulation method, a spray-dry method or the like may be used. Specifically, by mixing the resin material dissolved in an organic solvent with the magnetic powder coated with the low melting glass and drying the resulting object, a resin layer can be formed on the low melting glass of the magnetic powder.

FIG. 3 shows, in the left diagram, a magnetic powder 20 after granulation. As shown in FIG. 3, in the magnetic powder 20 after granulation, a magnetic powder 21 is coated with a low melting glass 31, and further the low melting glass 31 is coated with a resin material 32. As one example, the diameter of the magnetic powder 21 is 9 m, the thickness of the low melting glass 31 is 20 nm, and the thickness of the resin material is 20 nm.

In this embodiment, a magnetic powder not coated with a binder may also be present. In this embodiment, a thermosetting resin is preferably used as the binder.

Next, the magnetic powder after granulation is preformed (Step S4). For example, preforming can be conducted by putting the magnetic powder after granulation into a die for pressurization (e.g., 500 kgf/cm² at room temperature), and heating the pressed powder body (i.e., green compact) to a predetermined temperature (e.g., 100° C.-150° C.) and curing the pressed powder body without pressurization. When the resin material that is used is a thermosetting resin, the intermediate formed body is formed using curing of resin during heating. When the resin material that is used is a thermoplastic resin, the intermediate formed body is formed by softening of the resin during heating and solidification during cooling.

That is, as shown in the central diagram of FIG. 3, when the magnetic powder after granulation is preformed, the particles of the magnetic powder 21 (coated with the low melting glass 31) are bonded to one another via the outermost resin material 32 and an intermediate formed body 25 is formed. Since the low melting glass is not softened at the preforming temperature (e.g., 150° C.), it does not exhibit bonding and flow properties. Note that the preforming process (Step S4) may be omitted.

Next, the intermediate formed body after preforming (when Step S4 is omitted, magnetic powder after granulation) is subject to hot forming (Step S5). The hot forming is conducted by heating the intermediate formed body that has been preformed (or the magnetic powder after granulation) under pressure in a state in which it is put into the die. For example, the heating temperature is set as follows.

When the magnetic powder that has been used is a metallic glass alloy powder, the temperature when the magnetic powder is subject to hot forming is set to a temperature equal to or higher than one of a softening temperature of the low melting glass and a glass transition temperature of the magnetic powder which is higher than the other one, but is equal to or lower than a crystallization temperature of the magnetic powder. By setting the hot forming temperature to a temperature equal to or higher than the glass transition temperature of the magnetic powder, plastic deformation of the magnetic powder is more likely to occur, whereby a high filling percentage of the magnetic powder can be obtained. As one example, the hot forming temperature is equal to or higher than 450° C. but equal to or lower than 500° C.

When the magnetic powder that has been used is an amorphous alloy powder for nanocrystallization, the temperature when the magnetic powder is subject to hot forming is set to a temperature equal to or higher than one of a softening temperature of the low melting glass and a first crystallization temperature of the magnetic powder which is higher than the other one but is equal to or lower than a second crystallization temperature of the magnetic powder. By setting the hot forming temperature to a temperature around the first crystallization temperature, an a-Fe phase is precipitated, and at the same time plastic deformation of the magnetic powder becomes more likely to occur, whereby a high filling percentage of the magnetic powder can be obtained. As one example, the hot forming temperature is set to be a temperature equal to or higher than 400° C. but equal to or lower than 500° C. Further, in this embodiment, the hot forming temperature is preferably equal to or higher than one of the softening temperature of the low melting glass and the first crystallization temperature of the magnetic powder +40° C. which is higher than the other one. The first crystallization temperature and the second crystallization temperature are defined as follows. That is, heat treatment of the magnetic material having an amorphous structure causes crystallization to occur more than once during the temperature rising process. The temperature at which crystallization starts on a low temperature side is the first crystallization temperature and the temperature at which crystallization then starts on a high temperature side is the second crystallization temperature. More specifically, the magnetic powder includes at least two exothermic peaks that exhibit crystallization in the heating process of a DSC curve obtained by differential scanning calorimetry (DSC). Of the exothermic peaks, the exothermic peak on the lowest temperature side indicates the first crystallization temperature at which an α-Fe phase is precipitated, and the next exothermic peak indicates the second crystallization temperature at which a boride or the like is precipitated.

In this embodiment, the heating temperature is preferably set to a temperature in the aforementioned temperature range and temperature conditions are preferably such that the value of the iron loss of the powder magnetic core becomes small.

In this embodiment, the process of hot forming is carried out in an oxidizing atmosphere. Here, the oxidizing atmosphere is an atmosphere in which oxygen is present, typically in the air.

Further, in this embodiment, the heating rate during hot forming may be equal to or higher than 133° C./min, preferably equal to or higher than 200° C./min, more preferably equal to or higher than 500° C./min, and even more preferably equal to or higher than 1000° C./min. By setting the heating rate during hot forming to such a rate, the radial crushing strength of the powder magnetic core can be enhanced. In addition, by setting the heating rate equal to or higher than the aforementioned rate, heat is quickly transferred to the inside of a formed body, so that the thermal decomposition of the resin material used for the binder layer can be suppressed and the specific surface area can be reduced. Furthermore, when a thermosetting resin is used as the resin material, by setting the heating rate equal to or higher than the aforementioned rate, curing of the resin in the magnetic powder before plastic deformation can be suppressed on the surface of the powder magnetic core, and thus the specific surface area can be reduced.

The pressure when hot forming is performed is, for example, 5-10 ton·f/cm². If the pressure is too low, the filling percentage of the formed body (powder magnetic core) becomes low and the iron loss of the powder magnetic core becomes large. On the other hand, if the pressure is too high, the die is severely worn, which is not desirable in terms of cost. Therefore, the pressure is preferably set to a pressure in the aforementioned range.

Further, the pressurized holding time at the attained temperature (hot forming temperature) is preferably within a range of 5-300 seconds, and more preferably, equal to or shorter than 120 seconds. If the pressurized holding time is too short, heat does not sufficiently reach the inside of the formed body and a sufficient amount of deformation due to softening of the magnetic powder cannot be obtained, whereby the filling percentage of the formed body becomes low and the iron loss of the powder magnetic core becomes large. On the other hand, if the pressurized holding time is too long, thermal decomposition of the resin material used for the binder layer advances, whereby the effect of suppressing the flow properties of the low melting glass is reduced and the iron loss of the powder magnetic core becomes large. Therefore, the hot forming time may be set within a range in which heat is sufficiently transferred to the interior of the formed body, deformation due to softening of the magnetic core is completed, thermal decomposition of the resin material used for the binder layer does not advance, and the cost is not high. The forming time is preferably set to a time within the aforementioned range.

In addition, if the time of the hot forming is set within the above range, the filling percentage of the magnetic powder can be increased before the entire magnetic powder in the powder magnetic core is oxidized during the hot forming in the air, and thus oxidation inside the powder magnetic core can be suppressed.

In this embodiment, the magnetic powder may be heat-formed in a die that is preheated in the air. In this case, the magnetic powder that comes in contact with the die before the filling percentage of the magnetic powder is increased is oxidized, that is, only the surface of the powder magnetic core is oxidized, and thus the degradation of magnetic properties and strength can be minimized. Furthermore, the oxidation of the powder on the surface of the powder magnetic core increases the electrical resistance value of the surface of the powder magnetic core, thus improving the frequency characteristics and lowering the iron loss in the high frequency range (e.g., 1 MHz).

As shown in the right view of FIG. 3, in the formed body (powder magnetic core) 10 after the hot forming, the particles of the magnetic powder 21 are bonded to one another via the binder layer 22 including a low melting glass and a resin material. In this embodiment, the volume percentage of the particles of the magnetic powder contained in the powder magnetic core 10 is set to be 85 volume % or higher. The value obtained by dividing the BET specific surface area (m²/g) of the powder magnetic core after the hot forming by the specific surface area (m²/g) calculated using the outer dimensions of the powder magnetic core shall be 5000 or less. Thus, the powder magnetic core having a low loss in a high frequency range can be achieved.

That is, in this embodiment, since the particles of the magnetic powders 21 are bonded to one another via the binder layer 22, it is possible to suppress the intrusion of the air from the outside of the powder magnetic core 10 into the inside of the powder magnetic core, thereby suppressing the oxidation of the inside of the powder magnetic core. In this embodiment, the value obtained by dividing the BET specific surface area (m²/g) of the powder magnetic core after the hot forming by the specific surface area (m²/g) calculated using the outer dimensions of the powder magnetic core (ratio of specific surface areas) is set to equal to or less than 5000. When the ratio of the specific surface areas is set within such a range, the surface area of the powder magnetic core after the hot forming can be reduced (i.e., the surface can be smoothed). With such a small surface area, the area in contact with the outside air can be reduced, so that oxidation of the powder magnetic core can be suppressed. In addition, since the number of pores of the powder magnetic core can also be reduced, the oxidation inside the powder magnetic core can also be suppressed. Therefore, a powder magnetic core having a low loss in a high frequency range can be achieved. Further, when the temperature range of the hot forming is set to the above temperature range, the thermal decomposition of the binder can be suppressed, so that the decrease in the strength of the powder magnetic core can be suppressed. Moreover, in this embodiment, since the hot forming is performed in the air, the manufacturing cost can be reduced.

### EXAMPLES

Next, Examples according to the present disclosure will be described.

### Experiment 1

Samples according to Experiment 1 were prepared using the aforementioned method for manufacturing the powder magnetic core (see FIG. 2). The powder magnetic core according to Experiment 1 was formed in a toroidal shape having an outer diameter of 13 mm, an inner diameter of 8 mm, and a height of 5 mm. First, a magnetic powder was prepared. An Fe—Si—B—P—Cu—Cr-based powder, which is an amorphous alloy powder for nanocrystallization having a particle size of 10 μm (median diameter D50), was used as the magnetic powder. Next, the magnetic powder and a low melting glass powder were mixed, and the magnetic powder was coated with a low melting glass using a mechanochemical method. A phosphate-based glass was used as the low melting glass.

After that, the magnetic powder coated with the low melting glass was coated with a resin material and was granulated. A phenol resin was used for the resin material. The amount of binder for each sample, i.e., the total amount of the low melting glass and the resin material, was the amount of binder shown in Table 1. The ratio of the amount of the low melting glass to that of the resin material was 1:1. For example, when the amount of binder was 5 vol %, the amount of low melting glass was 2.5 vol % and the amount of resin material was 2.5 vol %.

Next, the magnetic powder after granulation was put into a die and pressurized at 500 kgf/cm², and then the pressed powder body was heated and cured at 150° C. without pressurization, thereby preforming the intermediate formed body. After that, the intermediate formed body after being preformed was subject to hot forming in a state in which it is put into a die. The hot forming was performed under a forming temperature of 480° C., a pressing pressure of 5 to 10 tonf/cm², and for a pressing time of 15 seconds. The heating rate was the one shown in Table 1.

The softening temperature of the low melting glass used in Experiment 1 was 400° C., the first crystallization temperature of the magnetic powder was 440° C., and the second crystallization temperature was 525° C. Therefore, in Experiment 1, the magnetic powder was formed at 480° C., which is the temperature between the first and second crystallization temperatures, and nanocrystallized during forming. That is, in Experiment 1, the structure of the magnetic powder before forming was the amorphous phase, and the structure of the magnetic powder after forming was the nanocrystalline phase.

In Experiment 1, hot-formed samples were prepared both in the air and in the inert atmosphere.

For each sample prepared as described above, the volume filling percentage of the powder magnetic core, the ratio of the specific surface areas, the magnetic permeability at 1 MHz, and the iron loss at 1 MHz and 50 mT were measured.

The volume filling percentage of the powder magnetic core was obtained using the following expression:

Volume filling percentage(%)=(density of the powder magnetic core calculated from the outer dimensions and weight of the powder magnetic core/true density of magnetic powder)×100

The ratio of the specific surface areas was obtained as follows.

First, the BET specific surface area A(m²/g) of the powder magnetic core was obtained. Using the outer dimensions of the powder magnetic core, the specific surface area B(m²/g) of the powder magnetic core was also obtained. The ratio of the specific surface areas (A/B) was obtained by dividing the specific surface area A(m²/g) by the specific surface area B (m²/g).

The magnetic permeability was obtained using an impedance analyzer at a frequency of 1 MHz. The measurement was performed at a frequency of 1 MHz. The iron loss was obtained by preparing a powder magnetic core having a toroidal shape and measuring the prepared powder magnetic core using a B—H analyzer (manufactured by IWATSU ELECTRIC CO., LTD.) by a two-coil method. The measurement was performed under sinusoidal excitation with 1 MHz and 50 mT.

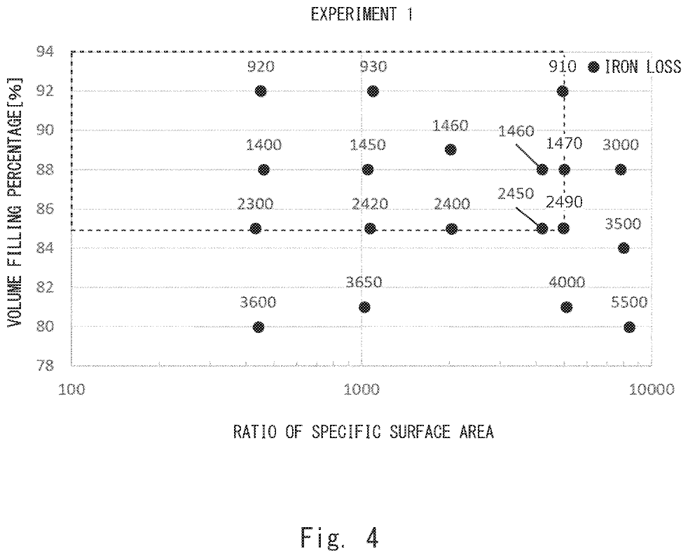

Table 1 shows the preparation conditions and measurement results for each sample. The graph in FIG. 4 shows a relationship between the ratio of the specific surface areas of the powder magnetic core, the volume filling percentage, and the iron loss. As shown in Table 1, samples with a volume filling percentage of 85% or higher showed satisfactory magnetic properties with a magnetic permeability of 50 or more (see Example 1-1 to Example 1-13). It is considered that the higher the volume filling percentage, the larger a volume of a magnetic body per unit volume, and thus the higher the magnetic permeability.

As shown in FIG. 4, the iron loss at 1 MHz and 50 mT was equal to or less than 2500 kW/m³ for the sample with a volume filling percentage of equal to or higher than 85% and a ratio of specific surface areas of equal to or less than 5000, exhibiting satisfactory magnetic properties (see the frame shown by the dashed line in FIG. 4). In Example 1-1 to Example 1-13, the value of the iron loss was lower when the sample was formed in the air than that when it was formed in an inert atmosphere. When the volume filling percentage was equal to or higher than 85% and the ratio of the specific surface areas was equal to or less than 5000, it is considered that the surface of the powder magnetic core was moderately oxidized, which increased the electrical resistance value of the surface of the powder magnetic core and reduced the eddy-current loss of the powder magnetic core, resulting in a lower iron loss than that when the sample was formed in an inert atmosphere. When the volume filling percentage was less than 85% and the ratio of specific surface areas was equal to or larger than 5000, it is considered that the number of hollows of the powder magnetic core were increased and the powder magnetic core was excessively oxidized, resulting in an increased iron loss.

The thickness of the oxide layer of the surface was equal to or less than 0.5 mm for the sample in the example formed in the air. The thickness of the oxide layer on the surface was equal to or less than 3.5 mm for the sample in the comparative example formed in the air. The thickness of the oxide layer on the surface was equal to or less than 0.01 mm for the sample formed in the inert atmosphere. From these results, it is preferable that the oxide layer on the surface of the sample be thicker than 0.01 mm. It should be noted that the oxide layer on the surface of the sample was equal to or less than 2 mm thick when the intermediate formed body was subjected to hot forming in the air using only a resin material as a binder.

TABLE 1

| | | | | | | | Iron loss at 1 MHz, 50 | |
|---|---|---|---|---|---|---|---|---|
| | | | | | Ratio of | | mT [kW/m³] | |
| | Amount of | Molding | Heating | Filling | specific | | | Molding in |
| | binder | pressure | rate | percentage | surface | Permeability | Molding | inert |
| | [vol %] | [t/cm²] | [° C./min] | [%] | areas | at 1 MHz | in air | atmosphere |
| Example 1-1 | 5 | 10 | 2000 | 92 | 450 | 115 | 920 | 1350 |
| Example 1-2 | 8 | 10 | 2000 | 88 | 460 | 80 | 1400 | 1500 |
| Example 1-3 | 12 | 10 | 2000 | 85 | 430 | 60 | 2300 | 2400 |
| Comparative | 12 | 5 | 2000 | 80 | 440 | 45 | 3600 | 3000 |
| example 1-1 | | | | | | | | |
| Example 1-4 | 5 | 10 | 1000 | 92 | 1100 | 114 | 930 | 1330 |
| Example 1-5 | 8 | 10 | 1000 | 88 | 1050 | 79 | 1450 | 1490 |
| Example 1-6 | 12 | 10 | 1000 | 85 | 1070 | 58 | 2420 | 2475 |
| Comparative | 12 | 5 | 1000 | 81 | 1020 | 45 | 3650 | 2950 |
| example 1-2 | | | | | | | | |
| Example 1-7 | 8 | 10 | 500 | 89 | 2020 | 79 | 1460 | 1490 |
| Example 1-8 | 12 | 10 | 500 | 85 | 2050 | 57 | 2400 | 2430 |
| Example 1-9 | 8 | 10 | 200 | 88 | 4200 | 78 | 1460 | 1480 |
| Example 1-10 | 12 | 10 | 200 | 85 | 4190 | 56 | 2450 | 2490 |
| Example 1-11 | 5 | 10 | 133 | 92 | 4950 | 113 | 910 | 1370 |
| Example 1-12 | 8 | 10 | 133 | 88 | 5000 | 76 | 1470 | 1510 |
| Example 1-13 | 12 | 10 | 133 | 85 | 4970 | 55 | 2490 | 2500 |
| Comparative | 12 | 5 | 133 | 81 | 5110 | 42 | 4000 | 3050 |
| example 1-3 | | | | | | | | |
| Comparative | 5 | 10 | 80 | 88 | 7840 | 70 | 3000 | 1500 |
| example 1-4 | | | | | | | | |
| Comparative | 8 | 10 | 80 | 84 | 7980 | 48 | 3500 | 2460 |
| example 1-5 | | | | | | | | |
| Comparative | 12 | 10 | 80 | 80 | 8390 | 35 | 5500 | 3100 |
| example 1-6 | | | | | | | | |

### Experiment 2

Samples according to Experiment 2 were prepared using the aforementioned method for manufacturing the powder magnetic core (see FIG. 2). The powder magnetic core according to Experiment 2 was formed in a toroidal shape having an outer diameter of 13 mm, an inner diameter of 8 mm, and a height of 5 mm. First, a magnetic powder was prepared. An Fe—B—P—Nb—Cr-based powder, which is a metallic glass alloy powder (an amorphous alloy powder) having a particle size of 9 μm (median diameter D50), was used as the magnetic powder. Next, the magnetic powder and a low melting glass powder were mixed, and the magnetic powder was coated with a low melting glass using a mechanochemical method. A phosphate-based glass was used as the low melting glass.

After that, the magnetic powder coated with the low melting glass was coated with a resin material and was granulated. A phenol resin was used for the resin material. The amount of binder for each sample, i.e., the total amount of the low melting glass and the resin material, was the amount of binder shown in Table 2. The ratio of the amount the low melting glass to that of the resin material was 1:1. For example, when the amount of binder was 5 vol %, the amount of low melting glass was 2.5 vol % and the amount of resin material was 2.5 vol %.

Next, the magnetic powder after granulation was put into a die and pressurized at 500 kgf/cm², and then the pressed powder body was heated and cured at 150° C. without pressurization, thereby preforming the intermediate formed body. After that, the intermediate formed body after being preformed was subject to hot forming in a state in which it is put into a die. The hot forming was performed under a forming temperature of 490° C., a pressing pressure of 5 to 10 tonf/cm², and for a pressing time of 15 seconds. The heating rate was the one shown in Table 2.

The softening temperature of the low melting glass used in Experiment 2 was 400° C., the glass transition temperature of the magnetic powder was 480° C., and the crystallization temperature was 510° C. In Experiment 2, the glass was formed at 490° C., which is the temperature between the glass transition temperature and the crystallization temperature. Therefore, in Experiment 2, the structure of the formed magnetic powder was also in an amorphous phase (which means that it was not crystallized).

In Experiment 2, hot-formed samples were prepared both in the air and in the inert atmosphere.

For each sample prepared as described above, the volume filling percentage of the powder magnetic core, the ratio of the specific surface areas, the magnetic permeability at 1 MHz, and the iron loss at 1 MHz and 50 mT were measured. The methods for measuring them are the same as those in Experiment 1.

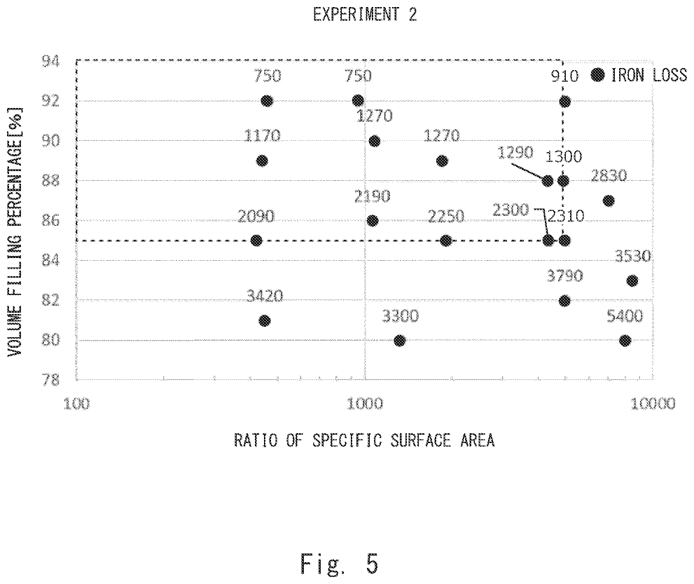

Table 2 shows the preparation conditions and measurement results for each sample. The graph in FIG. 5 shows a relationship between the ratio of the specific surface areas of the powder magnetic core to the volume filling percentage and the iron loss. As shown in Table 2, samples with a volume filling percentage of 85% or higher showed satisfactory magnetic properties with a magnetic permeability of 50 or more (see Example 2-1 to Example 2-13). It is considered that the higher the volume filling percentage, the larger a volume of a magnetic body per unit volume, and thus the higher the magnetic permeability.

As shown in FIG. 5, the iron loss at 1 MHz and 50 mT was equal to or smaller than 2500 kW/m³ for the sample with a volume filling percentage of equal to or higher than 85% and a ratio of specific surface areas of equal to or less than 5000, exhibiting satisfactory magnetic properties (see the frame shown by the dashed line in FIG. 5). In Example 2-1 to Example 2-13, the value of the iron loss was lower when the sample was formed in the air than that when it was formed in an inert atmosphere. When the volume filling percentage was equal to or higher than 85% and the ratio of the specific surface areas was equal to or less than 5000, it is considered that the surface of the powder magnetic core was moderately oxidized, which increased the electrical resistance value of the surface of the powder magnetic core and reduced the eddy-current loss of the powder magnetic core, resulting in a lower iron loss than that when the sample was formed in an inert atmosphere. When the volume filling percentage was less than 85% and the ratio of specific surface areas was equal to or larger than 5000, it is considered that the number of hollows of the powder magnetic core were increased and the powder magnetic core was excessively oxidized, resulting in an increased iron loss.

TABLE 2

| | | | | | | | Iron loss at 1 MHz, 50 | |
|---|---|---|---|---|---|---|---|---|
| | | | | | Ratio of | | mT [kW/m³] | |
| | Amount of | Molding | Heating | Filling | specific | | | Molding in |
| | binder | pressure | rate | percentage | surface | Permeability | Molding | inert |
| | [vol %] | [t/cm²] | [° C./min] | [%] | areas | at 1 MHz | in air | atmosphere |
| Example 2-1 | 5 | 10 | 2000 | 92 | 460 | 125 | 750 | 1130 |
| Example 2-2 | 8 | 10 | 2000 | 89 | 440 | 89 | 1170 | 1250 |
| Example 2-3 | 12 | 10 | 2000 | 85 | 420 | 68 | 2090 | 2250 |
| Comparative | 12 | 5 | 2000 | 81 | 450 | 47 | 3420 | 2850 |
| example 2-1 | | | | | | | | |
| Example 2-4 | 5 | 10 | 1000 | 92 | 950 | 123 | 750 | 1150 |
| Example 2-5 | 8 | 10 | 1000 | 90 | 1080 | 89 | 1270 | 1310 |
| Example 2-6 | 12 | 10 | 1000 | 86 | 1060 | 65 | 2190 | 2260 |
| Comparative | 12 | 5 | 1000 | 80 | 1330 | 49 | 3300 | 2780 |
| example 2-2 | | | | | | | | |
| Example 2-7 | 8 | 10 | 500 | 89 | 1850 | 88 | 1270 | 1290 |
| Example 2-8 | 12 | 10 | 500 | 85 | 1920 | 64 | 2250 | 2270 |
| Example 2-9 | 8 | 10 | 200 | 88 | 4300 | 87 | 1290 | 1330 |
| Example 2-10 | 12 | 10 | 200 | 85 | 4350 | 62 | 2300 | 2350 |
| Example 2-11 | 5 | 10 | 133 | 92 | 4950 | 113 | 910 | 1370 |
| Example 2-12 | 8 | 10 | 133 | 88 | 4890 | 84 | 1300 | 1330 |
| Example 2-13 | 12 | 10 | 133 | 85 | 4970 | 60 | 2310 | 2340 |
| Comparative | 12 | 5 | 133 | 82 | 4950 | 45 | 3790 | 2950 |
| example 2-3 | | | | | | | | |
| Comparative | 5 | 10 | 80 | 87 | 7040 | 75 | 2830 | 1400 |
| example 2-4 | | | | | | | | |
| Comparative | 8 | 10 | 80 | 83 | 8520 | 53 | 3530 | 2250 |
| example 2-5 | | | | | | | | |
| Comparative | 12 | 10 | 80 | 80 | 8010 | 40 | 5400 | 3250 |
| example 2-6 | | | | | | | | |

### Experiment 3

Samples according to Experiment 3 were prepared using the aforementioned method for manufacturing the powder magnetic core (see FIG. 2). The powder magnetic core according to Experiment 3 was formed in a toroidal shape having an outer diameter of 13 mm, an inner diameter of 8 mm, and a height of 5 mm. First, a magnetic powder was prepared. An Fe—Si—B—P—Cu—Cr-based powder, which is an amorphous alloy powder for nanocrystallization having a particle size of 10 μm (median diameter D50), was used as the magnetic powder. Next, the magnetic powder and a low melting glass powder were mixed, and the magnetic powder was coated with a low melting glass using a mechanochemical method. A phosphate-based glass was used as the low melting glass.

After that, the magnetic powder coated with the low melting glass was coated with a resin material and was granulated. A phenol resin was used for the resin material. The amount of binder for each sample, i.e., the total amount of the low melting glass and the resin material, was 8 vol %. The ratio of the amount of the low melting glass to that of the resin material was 1:1. For example, when the amount of binder was 8 vol %, the amount of low melting glass was 4 vol % and the amount of resin material was 4 vol %.

Next, the magnetic powder after granulation was put into a die and pressurized at 500 kgf/cm², and then the pressed powder body was heated and cured at 150° C. without pressurization, thereby preforming the intermediate formed body. After that, the intermediate formed body after being preformed was subject to hot forming in the air in a state in which it is put into a die. The hot forming was performed under a forming temperature of 480° C., a pressing pressure of 10 tonf/cm², and for a pressing time of 15 seconds. The heating rate was the one shown in Table 3.

The softening temperature of the low melting glass used in Experiment 3 was 400° C., the first crystallization temperature of the magnetic powder was 440° C., and the second crystallization temperature was 525° C. Therefore, in Experiment 3, the magnetic powder was formed at a temperature between the first and second crystallization temperatures, and nanocrystallized during forming. That is, in Experiment 3, the structure of the magnetic powder before forming was the amorphous phase, and the structure of the magnetic powder after forming was the nanocrystalline phase.

For each sample prepared as described above, the volume filling percentage of the powder magnetic core and the radial crushing strength were measured. The volume filling percentage was measured using the same method as that in Experiment 1. The radial crushing strength was calculated by compressive fracture of a toroidal-shaped powder magnetic core with a strength tester.

Table 3 shows the heating rate, the volume filling percentage, and the radial crushing strength of each sample. As shown in Table 3, the volume filling percentage was 85% or higher for the samples formed at a heating rate of 133° C./min or higher. The radial crushing strength was 30 MPa or higher for the samples formed at the heating rate of 133° C./min or higher. The radial crushing strength was 30 MPa or higher, which is desirable in terms of strength. Therefore, a powder magnetic core with satisfactory strength and magnetic properties of the sample can be prepared at the heating rate of 133° C./min or higher.

TABLE 3

| | | | Ratio of | Radial |
|---|---|---|---|---|
| | Heating | Filling | specific | crushing |
| | rate | percentage | surface | strength |
| | [° C./min] | [%] | areas | [MPa] |
| Comparative | 80 | 84 | 7980 | 20 |
| example 3-1 | | | | |
| Example 3-1 | 133 | 88 | 5000 | 30 |
| Example 3-2 | 200 | 88 | 4200 | 32 |
| Example 3-3 | 500 | 89 | 2020 | 33 |
| Example 3-4 | 1000 | 88 | 1050 | 37 |
| Example 3-5 | 2000 | 88 | 460 | 38 |

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A powder magnetic core in which a magnetic powder is bonded via a binder layer, wherein
a volume filling percentage of the magnetic powder included in the powder magnetic core is 85 volume % or higher, and
a value obtained by dividing a BET specific surface area (m²/g) of the powder magnetic core by a specific surface area (m²/g) calculated using outer dimensions of the powder magnetic core is 5000 or less.

2. The powder magnetic core according to claim 1, wherein an iron loss at 1 MHz and 50 mT of the powder magnetic core is equal to or smaller than 2500 kW/m³.

3. The powder magnetic core according to claim 1, wherein magnetic permeability of the powder magnetic core at 1 MHz is equal to or larger than 50.

4. The powder magnetic core according to claim 1, wherein a thickness of an oxide layer on a surface of the powder magnetic core is equal to or smaller than 3 mm.

5. The powder magnetic core according to claim 1, wherein
the magnetic powder is a soft magnetic powder that contains an iron element, and
the particle size of the magnetic powder is equal to or larger than 2 μm but equal to or smaller than 100 μm.

6. The powder magnetic core according to claim 5, wherein
the magnetic powder is a metallic glass alloy powder or a powder for nanocrystallization in which a nanocrystalline phase is precipitated in an amorphous phase.

7. The powder magnetic core according to claim 1, wherein the binder layer comprises a low melting glass and a resin material.

8. The powder magnetic core according to claim 7, wherein the total amount of the low melting glass and the resin material with respect to the amount of the magnetic powder is equal to or smaller than 12 volume %.

9. The powder magnetic core according to claim 7, wherein the low melting glass is a phosphate-based or a tin phosphate-based glass.

10. The powder magnetic core according to claim 7, wherein the resin material is at least one type of resin material selected from the group consisting of a phenol resin, a polyimide resin, an epoxy resin, and an acrylic resin.

11. An inductor comprising the powder magnetic core according to claim 1, and a coil.

12. A method for manufacturing a powder magnetic core comprising:
a process of coating a magnetic powder with a low melting glass;
a process of coating the magnetic powder coated with the low melting glass with a resin material for granulation; and
a process of hot forming the magnetic powder after the granulation, wherein
a volume filling percentage of the magnetic powder included in the powder magnetic core after the hot forming is 85 volume % or higher, and
a value obtained by dividing a BET specific surface area (m²/g) of the powder magnetic core after the hot forming by a specific surface area (m²/g) calculated using outer dimensions of the powder magnetic core is 5000 or less.

13. The method for manufacturing the powder magnetic core according to claim 12, wherein the process of hot-forming is performed in an oxidizing atmosphere.

14. The method for manufacturing the powder magnetic core according to claim 12, wherein a heating rate during the hot-forming is equal to or higher than 133° C./min.

15. The method for manufacturing the powder magnetic core according to claim 12, wherein
the magnetic powder is a metallic glass alloy powder, and
the temperature during the hot forming is equal to or higher than one of a softening temperature of the low melting glass and a glass transition temperature of the magnetic powder which is higher than the other one but is equal to or lower than a crystallization temperature of the magnetic powder.

16. The method for manufacturing the powder magnetic core according to claim 12, wherein
the magnetic powder is an amorphous alloy powder for nanocrystallization, and
the temperature during the hot forming is equal to or higher than one of a softening temperature of the low melting glass and a first crystallization temperature of the magnetic powder which is higher than the other one but is equal to or lower than a second crystallization temperature of the magnetic powder.

17. The method for manufacturing the powder magnetic core according to claim 12, wherein the total amount of the low melting glass and the resin material with respect to the amount of the magnetic powder is equal to or smaller than 12 volume %.

18. The method for manufacturing the powder magnetic core according to claim 12, wherein the low melting glass is a phosphate-based or a tin phosphate-based glass.

19. The method for manufacturing the powder magnetic core according to claim 12, wherein the resin material is at least one type of resin material selected from the group consisting of a phenol resin, a polyimide resin, an epoxy resin, and an acrylic resin.
